(19) United States
(12) Patent Application Publication
(10) Pub. No.: US 2007/0060120 A1
(43) Pub. Date: Mar. 15, 2007

(54) Telemetry system and facsimile machine

(76) Inventors: Reiner J. Gerdes, Atlanta, GA (US); Samuel D. Davis, Lawrenceville, GA (US); Fred R. Stearns, Acworth, GA (US); Mark E. Johnson, Stone Mountain, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/510,436

(22) Filed: Aug. 25, 2006

Related U.S. Application Data
(63) Continuation-in-part of application No. 10/630,050, filed on Jul. 30, 2003, now Pat. No. 7,110,778.
(63) Continuation-in-part of application No. 11/411,524, filed on Apr. 26, 2006.

(51) Int. Cl. H04Q 7/20

(52) U.S. Cl. 455/426.1

(57) ABSTRACT

The systems and methods disclosed herein relate to digital data communication systems, and more particularly, the systems and methods relate to systems and methods for facilitation digital communication between a first modem equipped facsimile machine and a second modem equipped facsimile machine. In one example, the system has the second modem equipped facsimile machine system or a first modem equipped facsimile machine that utilizes a modem for data communication, and a telemetry device with a processor for communicating with the first modem equipped facsimile machine and a digital cellular radio for communicating with the processor. The processor relays digital data from the first modem equipped facsimile machine to the digital cellular radio and the digital cellular radio transmits the digital data to the second modem equipped facsimile machine system. This system allows a user to transmit the digital data representing a document. This system facilitates bi-directional communication between a first modem equipped facsimile machine connected to a digital cellular or wireless network via the first telemetry device and a second modem equipped facsimile machine connected to a land (POTS) telephone line or wireless network via the second telemetry device. Data transport over PSTN or wireless networks can be via a circuit-switched or packet data connection.

### CROSS-REFERENCE TO RELATED APPLICATION

This application is a Continuation-in-Part application of co-pending U.S. utility patent applications entitled “REMOTE TELEMETRY DEVICE,” having Ser. No. 10/630050, filed Jul. 30, 2003, and “REMOTE TELEMETRY DEVICE,” having Ser. No. 11,411524, filed Apr. 26, 2006, each of which are incorporated by reference in their entirety.

### TECHNICAL FIELD

This invention relates to digital data communication systems, and more particularly, the invention relates to a telemetry device, and systems and methods for facilitating digital communication between two modem equipped facsimile machines, wherein a telemetry device has a processor for communicating with the modem of a facsimile machine, and a digital cellular radio for communicating with the processor, wherein the processor relays the digital data from the modem of the facsimile machine to the digital cellular radio which transmits the digital data (e.g. documents) to a cell tower which in turn transmits the digital data to a second modem equipped facsimile machine over a land line or cellular network.

### BACKGROUND OF THE INVENTION

Facsimile machines are presently used for sending and receiving documents or drawings in the form of data. The connection between facsimile machines presently is via the Public Switched Telephone Network (PSTN). At the present time a facsimile machine cannot be used in a location where telephone lines are not available, such in mobile command centers and various remote locations. A breakdown or malfunction in the PSTN or its connection with a facsimile machine means that a facsimile (fax) can neither be sent nor received from this facsimile machine. There are also times when the amount of traffic over the PSTN lines to a business, or government office or residence prevents the transmission or receiving of facsimiles because sufficient lines are not available. There is a need for backup facsimile transmission capability.

The communication arena is presently the scene of competition between the landline carriers and the wireless carriers. Part of this battle is driven by rates and convenience. It would be desirable to have the capability to send and receive facsimiles between wireless networks or entirely within a wireless network or between a wireless network and a PSTN. In other words, it would be desirable to have a system where one facsimile machine was connected to a wireless network and the other facsimile machine was connected to a PSTN or another wireless network or the same wireless network.

### SUMMARY OF THE INVENTION

Systems and methods for facilitating digital wireless communication between the first modem equipped facsimile machine and a second modem equipped facsimile machine have been invented. The systems and methods use digital technology, such as digital cellular radio, digital networks, digital communication techniques (e.g., Time Division Multiple Access (TDMA), Code Division Multiple Access (CDMA), Global System for Mobile Communications (GSM), etc). The systems and methods can establish a bi-directional communication pathway that relays digital data (e.g., documents) between a first modem equipped facsimile machine and a second modem equipped facsimile machine.

This bi-directional communication pathway between facsimile machines can be established between a wireless and a PSTN (connected land telephone line) location or between wireless locations, (i.e., digital cellular service is linked to a first modem equipped facsimile machine and a second modem equipped facsimile machine.)

The telemetry device may have a modem-equipped device data manager with software to buffer the pages so that they are transmitted and received separately by the second modem equipped facsimile machine.

In one embodiment the digital data communication is established between a first modem equipped facsimile machine on a digital wireless network and a second modem equipped facsimile machine over a PSTN network.

In another embodiment, the digital communication between the facsimile machines is established over two digital wireless networks.

In a third embodiment, the digital data communication is established between the facsimile machines over a single digital wireless network.

This invention allows a user to transmit the digital data for facsimiles without the use of telephone lines. The system can use current digital cellular communication technology, such TDMA, CDMA, GSM, etc., and the modem inside the first modem equipped facsimile machine to facilitate digital data communication between the first modem equipped facsimile machine and the second modem equipped facsimile machine.

In another embodiment, a method for facilitating digital communication between a first modem equipped facsimile machine and a second modem equipped facsimile machine is provided, comprising the steps of detecting whether the first modem equipped facsimile machine is off hook, establishing a bidirectional communication pathway that relays data between the first modem equipped facsimile machine and the second modem equipped facsimile machine, and terminating the pathway by either the first modem equipped facsimile machine or the second modem equipped facsimile machine. The method further takes advantage of the cellular communication technology to relay digital data from a first modem equipped facsimile machine without the use of a land line telephone line. A modem equipped first facsimile machine connected to a telemetry device can be used to transmit data (documents) to a second facsimile machine connected to standard telephone line or a second telemetry device with a modem and cellular radio.

### BRIEF DESCRIPTION OF THE DRAWINGS

The disclosed systems and methods can be better understood with reference to the following drawings. The components in the drawings are not necessarily to scale.

FIG. 1A is a schematic view of an embodiment of a system through which digital data communication is established between a first modem equipped facsimile machine and a second modem equipped facsimile machine over digital wireless and PSTN networks.

FIG. 1B is a schematic view of an embodiment of the system through which digital data communication is established between a first modem equipped facsimile machine and a second modem equipped facsimile over two digital wireless networks.

FIG. 1C is a schematic view of an embodiment of a system through which digital data communication is established between a first modem equipped facsimile machine and a second modem equipped facsimile machine over a single digital wireless network.

FIG. 2 is a block diagram of an embodiment of a telemetry device shown in FIG. 1.

FIG. 3 is a flow diagram that illustrates an embodiment disclosing operation of the system shown in FIG. 1 in facilitating digital data communication between the first modem equipped facsimile and the second modem equipped facsimile machine.

FIG. 4A is a flow diagram that illustrates an embodiment of operation of the modem equipped data manager of the telemetry device shown in FIG. 2.

FIG. 4B is a flow diagram that illustrates another embodiment of operation of the modem equipped data manager of the telemetry device shown in FIG. 2.

FIG. 5 is a flow diagram that illustrates an embodiment of operation of the modem equipped data manager of the telemetry device shown in FIG. 2 in which the telemetry device receives instruction data from a second modem equipped facsimile machine.

### DETAILED DESCRIPTION OF THE PREFERRED EMBODIMENT

Disclosed herein are systems and methods in which digital data can be conveyed from a first modem equipped facsimile machine to a second modem equipped facsimile machine via a digital cellular radio and a cellular network. In particular, the digital data communication between the first modem equipped facsimile machine and the second modem equipped facsimile machine can be achieved using digital cellular technology, e.g., digital cellular radio, digital cellular networks, and digital cellular communication technology, such as Time Division Multiple Access (TDMA), Code Division Multiple Access (CDMA), Global System for Mobile Communications (GSM), etc. Examples of such systems are first discussed with reference to the figures. Although the systems are described in detail, they are provided for purposes of illustration only and various modifications are feasible. After the examples of such systems have been described, examples of operation of the systems are provided disclosing the manner in which the digital data, e.g., documents, drawings, etc. are relayed from the first modem equipped facsimile machine to the second modem equipped facsimile machine.

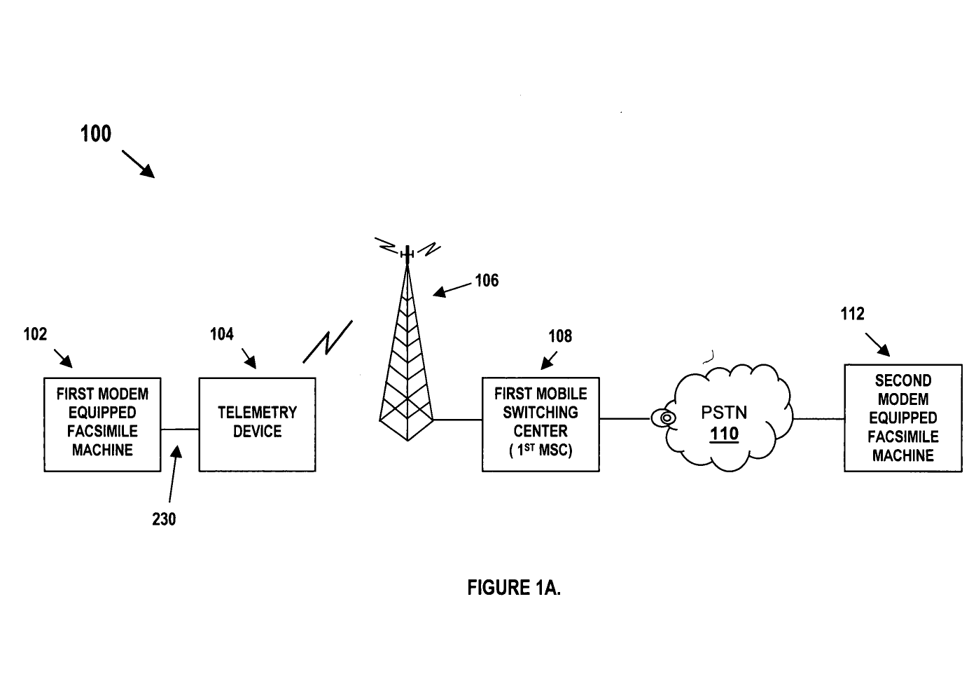

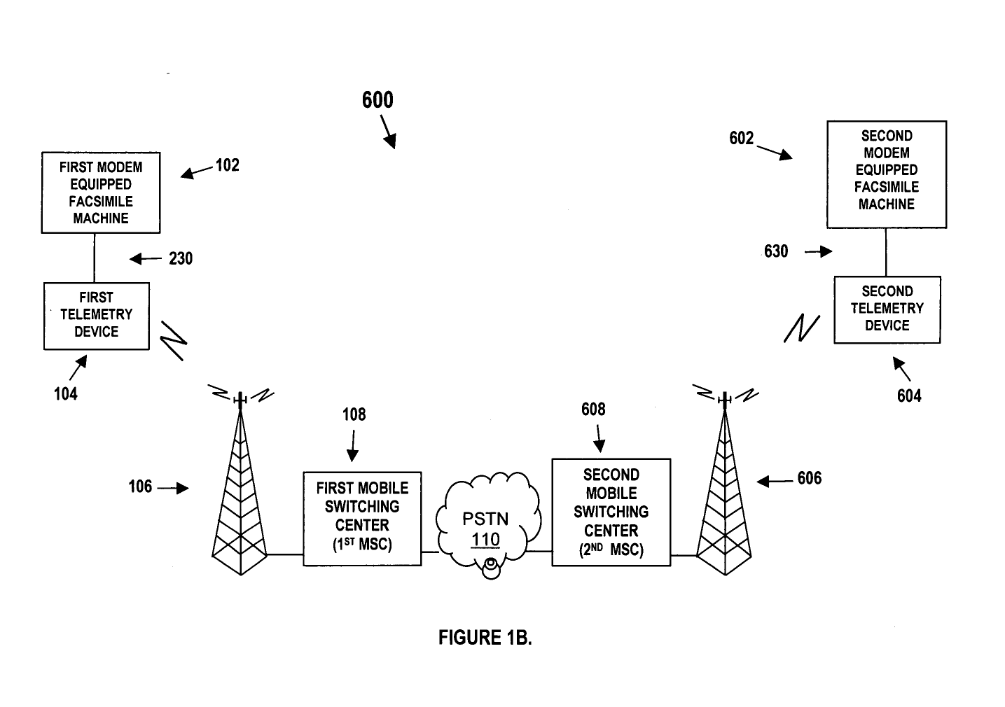

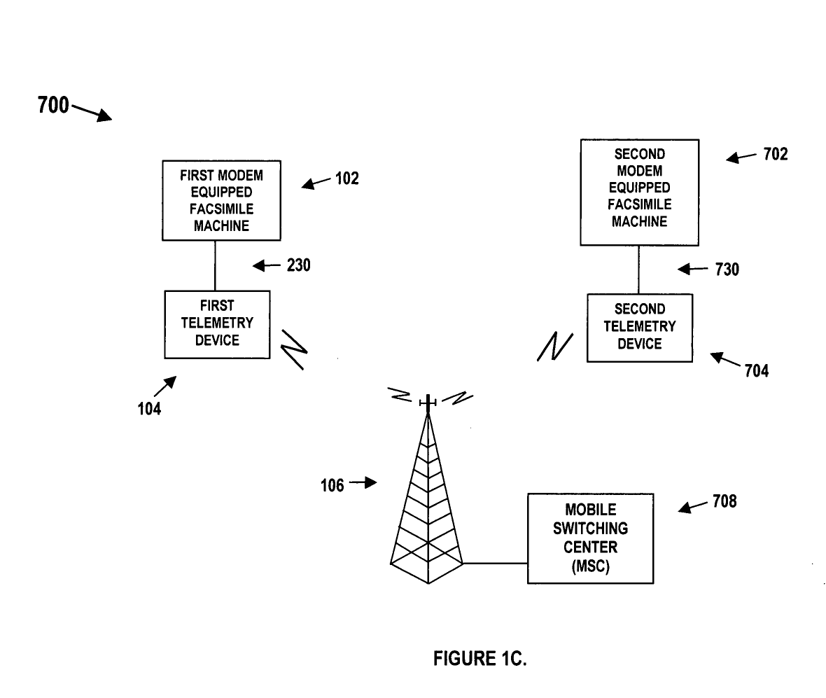

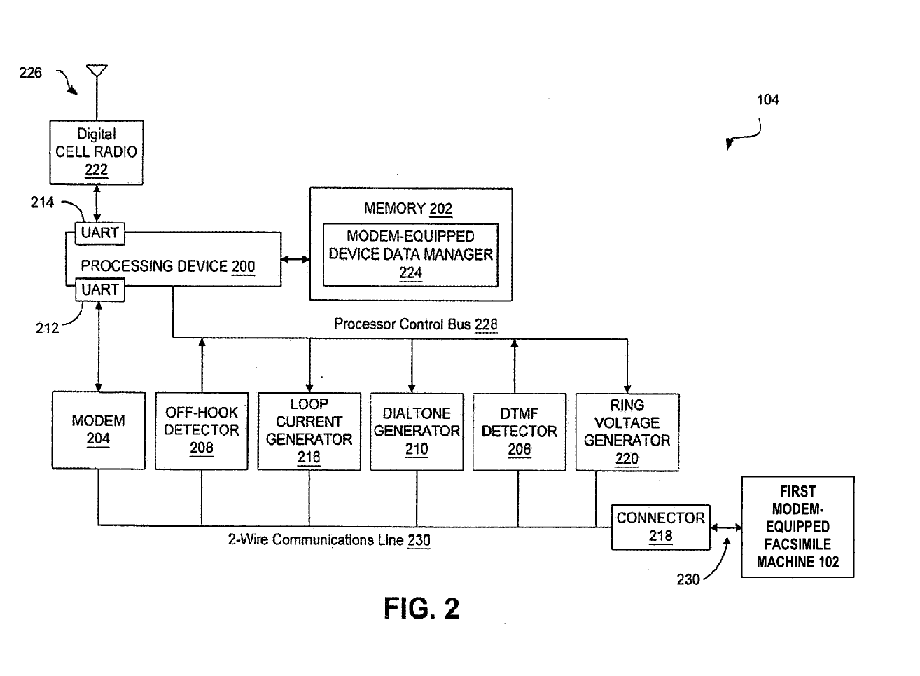

Referring now in more detail to the figures in which like reference numerals identify corresponding parts, FIG. 1A illustrates an example of a system 100 in which digital data (e.g., documents) from the first modem equipped facsimile machine 102 can be relayed to a second modem equipped facsimile machine 112 via a telemetry device 104. The digital data may be any data that can be transmitted by a facsimile machine, such as documents, drawings, etc. The system 100 can comprise one or more first modem equipped facsimile machines 102, one or more telemetry devices 104, one or more cell towers 106, one or more mobile switching centers (MSC) 108, a public switched telephone land lines network (PSTN) 110, and one or more second modem equipped facsimile machine 112. As shown in FIG. 1A, the first modem equipped facsimile machine 102 is electrically coupled to the telemetry device 104. The first modem equipped facsimile machine may include or be connected to a scanner for scanning documents to be sent over the system 100. It may also be connected to a computer for sending documents generated by the computer. As shown in FIG. 2, a data transmission line 230 (e.g., two-wire line) couples the first modem equipped facsimile machine 102 and the telemetry device 104 to facilitate digital data communication.

The modems used with first modem equipped facsimile machine and second modem equipped facsimile machine can have a wide range of transmission rates and modulations, including Class I and II facsimile machines.

The telemetry device 104 gathers digital data, e.g., documents, from the first modem equipped facsimile machine 102. The telemetry device 104 relays the digital data from the first modem equipped facsimile machine 102 to the second modem equipped facsimile machine 112. The system 100 can be constructed or programmed so that the telemetry device 104 can receive instructions from the second modem equipped facsimile machine 112 to transmit digital data from the first modem equipped facsimile machine 102. The telemetry device 104 can establish a bi-directional communication pathway that relays data between the first modem equipped facsimile machine 102 and the second modem equipped facsimile machine 112. The telemetry device 104 basically acts as a transmission interface between the first modem equipped facsimile machine 102 and second modem equipped facsimile machine 112 to control the flow of data over the system 100.

The cell tower 106 is part of a digital cellular network that communicates with the telemetry device 104 for the purpose of gathering data from the first modem equipped facsimile machine 102. The cell tower 106 is connected to the mobile switching center 108 (MSC). The MSC 108 manages cellular calls to and from cellular radios in a given service area. The MSC 108 is coupled to the Public Switched Telephone Network (PSTN) 110, which is coupled to the second modem equipped facsimile machine 112. It should be understood that the term PSTN 110 in FIG. 1A includes any type of electronic connection between the MSC 108 and the second modem equipped facsimile machine 112. The term PSTN also includes the standard telephone line (POTS).

Data transmission over the PSTN or wireless networks can be via a circuit-switched connection or it can be sent by packets. A modem bank is necessary in connection with the Mobile Switching Center (MSC) for circuit switching. An Inter-working Facility (IWF), with a modem bank, forms an integral part of the circuit switched connection. A modem bank is not needed if the transmission is with packet data.

Transmission can be either over different cellular networks or within a single cellular network or between a cellular network and the PSTN.

FIG. 1B illustrates an example of a system 600 in which digital data from the first modem equipped facsimile machine 102 can be relayed to a second modem equipped facsimile machine 602, each of which is connected to a separate digital wireless network. As in the case illustrated in FIG. 1A, the system 600 has one or more first modem equipped facsimile machines 102, one or more first telemetry devices 104, one or more cell towers 106 and one or more first mobile switching center (1^{st} MSC) 108, a public switched land network (PSTN) 110, and one or more second modem equipped facsimile machines 602. As shown in FIG. 1B, the first modem equipped facsimile machine 102 is electrically coupled to first telemetry device 104 via a two-wire communication line 230 in the same way as illustrated in FIG. 1A. The first telemetry device 104 can establish a bi-directional communication pathway via cell tower 106. Cell tower 106 is connected to the first mobile switching center (1^{st} MSC) 108 which is coupled to the public switched telephone network (PSTN) 110.

The PSTN 110 is coupled to the second mobile switching center (2^{nd} MSC) 608 which is connected to the second cell tower 606 through which a bi-directional communication pathway is established to the second telemetry device 604 which is connected by a two-wire communication link 630 to the second modem equipped facsimile machine 602.

FIG. 1C illustrates an example of a system 700 in which digital data from a first modem equipped facsimile machine 102 can be relayed to a second modem equipped facsimile machine 702 via a single digital wireless network. The system 700 can comprise one or more first modem equipped facsimile machines 102, one or more first telemetry devices 104, one or more cell towers 106 and one or more mobile switching centers (MSC) 708, and one or more second modem equipped facsimile machines 702. The first modem equipped facsimile machine 102 of system 700 is connected via a two-wire communication link 230 to the first telemetry device 104 which establishes a bi-directional pathway that relays data between the first modem equipped facsimile machine 102 to the second modem equipped facsimile machine 112 over cell tower 106. Cell tower 106 is connected to the mobile switching center (MSC) 708. A bi-directional communication pathway is established between cell tower 106 and the second telemetry device 704 which is connected to the second modem equipped facsimile machine 702 via a two-wire communication link 730.

Facsimiles can also be sent over the RAM mobile data system.

The system 700 operates in the same way as the system 600 illustrated in FIG. 1B except that FIG. 1C illustrates a system 700 which is entirely within a single digital wireless network.

FIG. 2 is a block diagram of the telemetry device 104 shown in FIGS. 1A and 1B and 1C. As indicated in FIG. 2, the telemetry device 104 has an antenna 226, digital cellular radio 222, processing device 200, and connector 218. The telemetry device 104 may further comprise Universal Asynchronous Receiver/Transmitters (UARTs) 212, 214, modem 204, off-hook detector 208, loop current generator 216, memory 202, ring voltage generator 220, a dial tone generator 210 and a dual tone multi-frequency (DTMF) detector 206. The processing device 200 can include any custom made or commercially available processor, a semiconductor base microprocessor (in the form of a micro chip), or a macroprocessor. The memory 202 can include any one or a combination of volatile memory elements (e.g., random access memory (RAM), such as DRAM, SRAM, etc.) and non-volatile memory elements (e.g., ROM, etc.).

The connector (or terminal block) 218 is coupled to the first modem equipped facsimile machine 102, via a data transmission line, e.g., two-wire communications line 230. In general, the connector 218 is any connection component that links the telemetry device 104 to the first modem equipped facsimile machine 102 in order to facilitate digital data communication between the first modem equipped facsimile machine 102 and the second modem equipped facsimile machine 112. The connector 218 can be a RJ11 or other means of two-wire connection.

The loop current generator 216 is coupled to connector 218 via the two-wire communications line 230 and generates current flow through the two-wire communications line 230 during communication between the telemetry device 104 and the first modem equipped facsimile machine 102. The loop current generator 216 generates loop current to the first modem equipped facsimile machine 102. When the first modem equipped facsimile machine 102 goes off-hook, the loop current begins flowing from the remote telemetry 104 to first modem equipped facsimile machine 102. When the first modem equipped facsimile machine 102 goes back on-hook, the loop current flow stops.

The off-hook detector 208 is also coupled to connector 218 via the two-wire communications line 230 and detects the loop current generated by the loop current generator 216. By detecting the loop current, the off-hook detector 208 can detect an off-hook condition of the first modem equipped facsimile machine 102 through the two-wire communications line 230 between the telemetry device 104 and the first modem equipped facsimile machine equipped device 102. When the off-hook detector 208 detects that first modem equipped facsimile machine 102 is off-hook, the detector 208 sends a signal to the processing device 200 indicating the off-hook condition. The processing device 200 may be programmed to activate the dial tone generator 210 to generate a dial tone to the first modem equipped facsimile machine 102. The processing device 200 may also send a command to the digital cellular radio 222 to dial a stored number in memory 202.

Also referring to FIG. 2, the ring voltage generator 220 is coupled to the connector 218 via the two-wire communications line 230 and provides a high voltage ring waveform on the data transmission line to the first modem equipped facsimile machine 102. When the first modem equipped facsimile machine 102 detects the ring voltage, the first modem equipped facsimile machine can be programmed to go off-hook.

The connector 218 is coupled to the modem 204 via the two-wire communications line 230 and the modem 204 is coupled to the processing device 200. The modem 204 handshakes with the modem of the first modem equipped facsimile machine 102 and establishes a communication connection between the first modem equipped facsimile machine and the processing device 200. UART 212 may be coupled to the modem 204 and processing device 200 to provide serial communication between the modem 204 and the processing device 200. UART 214 may be coupled to the processing device 200 and the cellular radio 222 to provide serial communication between the cellular radio 222 and the processing device 200.

The cellular radio 222 receives the digital data from the processing device 200 and facilitates relaying the digital data from the first modem equipped facsimile machine 102 to the second modem equipped facsimile machine 112. The cellular radio 222 also receives incoming digital data from the second modem equipped facsimile machine 112.

The telemetry device 104 may further comprise a dial tone generator 210 and a dual tone multi-frequency (DTMF) detector 206. Some first modem equipped facsimile machines 102 may communicate with the telemetry device 104 without a dial tone generator 210 and DTMF detector 206. However, some first modem equipped facsimile machines 102 may require the dial tone generator 210 and DTMF detector 206 to establish communication between the telemetry device 104 and the first modem equipped facsimile machine 102. The dial tone generator 210 generates a dial tone to the first modem equipped facsimile machine 102 when the first modem equipped facsimile machine 102 is off-hook. The first modem equipped facsimile machine 102 detects the dial tone and generates a DTMF digit. Once the remote telemetry 104 detects the DTMF digit from the first modem equipped facsimile machine 102, the dial tone generator 210 can be programmed to turn off.

In one example, the DTMF detector 206 may detect the initial generation of the first DTMF digit and turn off the dial tone generator 210. The first modem equipped facsimile machine 102 may continue to transmit the DTMF digits to the first modem equipped facsimile machine 104, but the processing device 200 ignores the remaining DTMF digits from the first modem equipped facsimile machine 102. The processing device 200 accesses a dial stored number that is preprogrammed in memory 202 and sends the dial stored number to the digital cellular radio 222 to dial to the cell towers 106.

In another example, the DTMF detector 206 may detect the DTMF digits from the first modem equipped facsimile machine 102. The DTMF digits are sent to the processing device 200, which collects all DTMF digits coming from the first modem equipped facsimile machine 102 and stores the DTMF digits in memory 202. The DTMF digits determine the number to be dialed to the cell tower 106. Once all DTMF digits are collected, the processing device 200 sends the DTMF digits from memory 202 to the digital cellular radio 222 to dial the cell tower 106.

Once the digital cellular radio 222 establishes the over-the-air cellular link, the processing device 200 activates the modem 204 which handshakes with the modem of the first modem equipped facsimile machine 102. The processing device 200 then relays the digital data via UARTs 214, 212 between the first modem equipped facsimile machine 102 and the second modem equipped facsimile machine 112. As the modem 204 receives the digital data from the first modem equipped facsimile machine 102, UART 212 serially communicates the data to the processing device 200 which relays the digital data to UART 214, which in turn serially transmits the data to the digital cellular radio 222 for sending out to the second modem equipped facsimile machine 112. Likewise, incoming data from the second modem equipped facsimile machine 112 can be relayed to the first modem equipped facsimile machine 102, thereby the telemetry device 104 can facilitate a bi-directional communication pathway that relays data between the first modem equipped facsimile machine 102 and the second modem equipped facsimile machine 112. It should be noted that the processing device 200 does not change or alter the data being relayed to and from the first modem equipped facsimile machine 102.

The bi-directional communication pathway can be terminated by either the first modem equipped facsimile machine 102 or the second modem equipped facsimile machine 112. When the first modem equipped facsimile machine 102 hangs up, the off-hook detector 208 detects an on-hook condition of the first modem equipped facsimile machine 102 and sends a signal to the processing device 200, which indicates a termination of the bi-directional communication pathway. When the second modem equipped facsimile machine hangs up, the digital radio 222 sends a signal to the processing device 200, which indicates a termination of the bi-directional communication pathway. The first modem equipped facsimile machine 102 and second modem equipped facsimile machine may also terminate the pathway by timing out or dialing a DTMF digit, such as # or *.

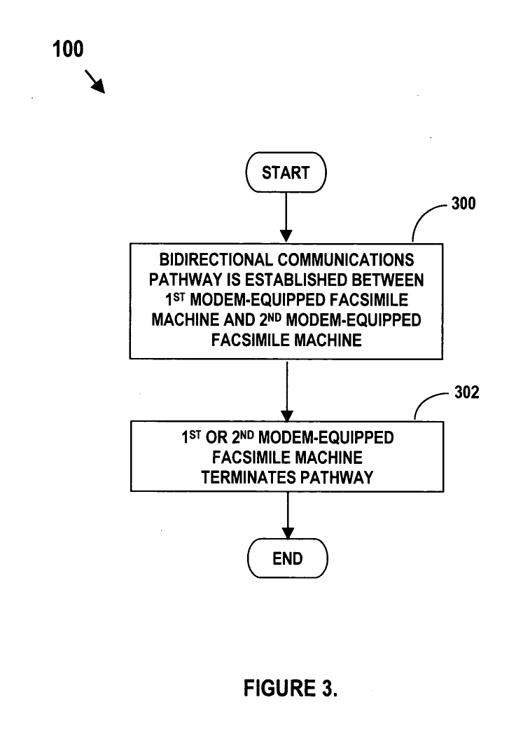

Referring to FIG. 2, it should be noted that modem 204, off-hook detector 208, loop current generator 216, ring voltage generator 222, dial tone generator 210 and DTMF detector 206 are coupled to processing device 200 via the processor control bus 228 such that the processing device 200 communicates with these electrical components and manages their activities. The processing device 200 further manages memory 202, which may include a modem equipped device data manager 224. Operation of the modem equipped device data manager 224 is further described with respect to FIGS. 3, 4, and 5. Software is needed for the general programming of the modem-equipped device data manager 224. Software for forming a buffer between pages sent by facsimile can be provided for the modem-equipped device data manager 224. This software will separate pages sent by facsimile so it is not a running document without page breaks.

The operation of the system described above is shown in flow diagrams, FIGS. 3-5. Any process steps or blocks in these full diagrams may represent modules, segments, or portions of code that include one or more executable instructions for implementing specific logical functions or steps in the process. Although specific process steps are described, alternative implementations are feasible. Moreover, steps may be executed out of order from that shown or discussed, including substantially concurrently or in reverse order, depending on the functionality involved.

FIG. 3 is a high level example of operation of the system 100 of FIG. 1 in facilitating digital communication between the first modem equipped facsimile machine 102 and the second modem equipped facsimile machine 112. With this system 100, a user can relay digital data from the first modem equipped facsimile machine 102 to the second modem equipped facsimile machine 112 without the use of telephone lines. However, a telephone line may be used between the mobile switching center (MSC) 108 and the second modem equipped facsimile machine 112 as shown in FIG. 1A. As shown in FIG. 1B, the data may be transmitted between first modem equipped facsimile machine 102 and the second modem equipped facsimile machine 112 by a wireless network. In either case, the system 100 provides a less expensive way of relaying digital data from the first modem equipped facsimile 102 to second modem equipped facsimile machine 112.

Beginning with block 300, the system 100 relays digital data from the first modem equipped device 102 to the second modem equipped facsimile machine 112. The digital data may represent for example, documents, drawings, photographs or anything that can be transmitted by a facsimile machine. The system 100 may also relay similar incoming data, or instruction data, from the second modem equipped facsimile machine 112 to the first modem equipped facsimile 102. The system 100 can establish a bidirectional communication pathway that relays data between the first modem equipped facsimile device 102 and the second modem equipped facsimile machine 112, shown in block 300. The first modem equipped facsimile 102 or the second modem equipped facsimile machine 112 may terminate the communication pathway as shown in block 302. The digital data and incoming data are relayed, not changed or altered, between the telemetry device 104 and the second modem equipped facsimile machine 112. Generally speaking, the second modem equipped facsimile machine 112 receives the digital data when a user decides to send a facsimile from the first modem equipped facsimile machine 102 to the second modem equipped facsimile machine 112. The first modem equipped facsimile machine 102 can be programmed to send the data at a certain time, e.g., hourly, daily, weekly, monthly, or upon an event, such as when it is sent by a computer to the first modem equipped facsimile machine.

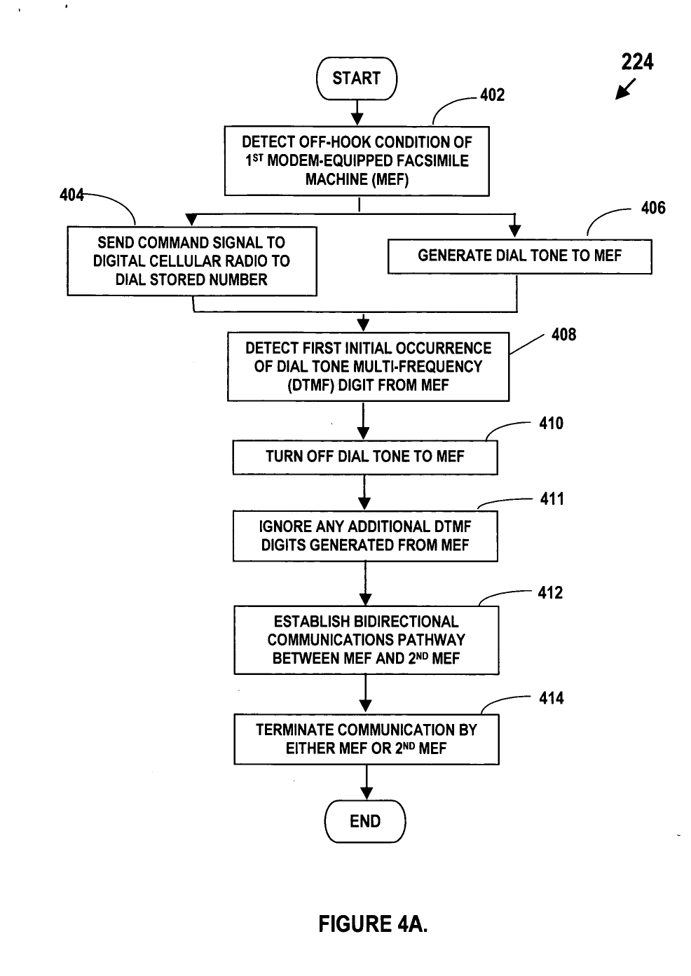

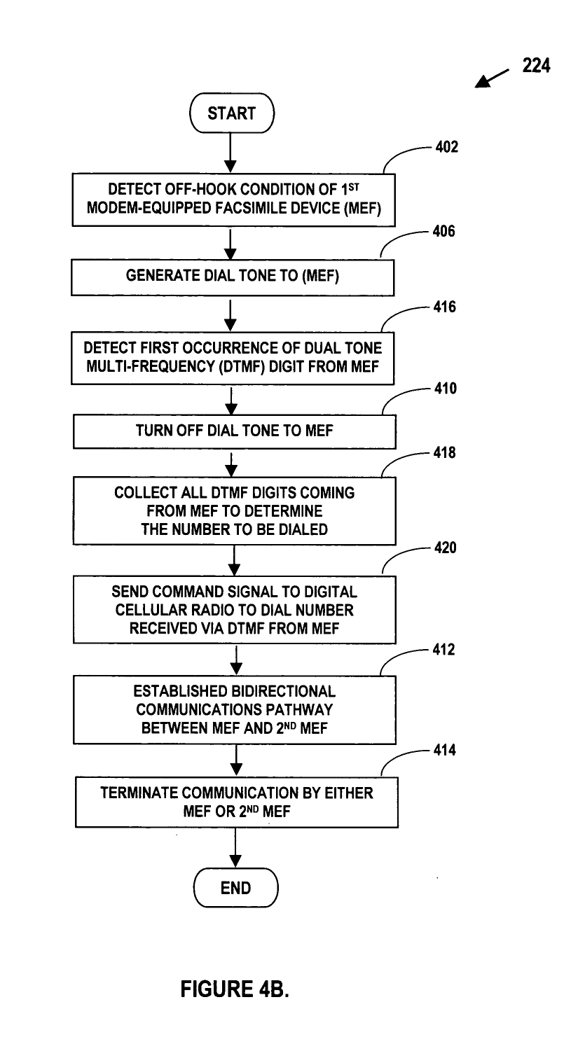

FIG. 4A illustrates an example of operation of a modem-equipped device data manager 224 that facilitates digital data communication between the first modem equipped facsimile machine 102 and the second modem equipped facsimile machine 112. The manager 224 is programmed to detect an off-hook condition of the first modem equipped facsimile machine 102, as shown in block 402 of FIG. 4A. Once the off-hook condition is detected, the manager 224 may send a command signal to the digital cellular radio 222 to dial a number to the cell tower 106, as shown in block 404. This number may have been stored in the memory 202 or generated at the time of dialing by a user of first modem equipped facsimile machine. The manager 224 further may instruct the dial tone generator 210 to generate a dial tone to the first modem equipped facsimile machine 102, as shown in block 406.

When the first modem equipped facsimile machine 102 receives the dial tone from the telemetry device 104, the first modem equipped facsimile machine 102 may generate the DTMF digits to the telemetry device 104. The modem equipped device data manager 224 may detect only the initial generation of the first DTMF digit or the first initial occurrence of DTMF digit from the first modem equipped facsimile machine 102, as shown in block 408. The manager 224 may also turn off the dial tone generator 210, as shown in block 410. The first modem equipped facsimile machine 102 may continue to dial the DTMF digit to the telemetry device 104, but the manager 224 ignores the remaining DTMF digits from the second modem equipped machine 102, as shown in block 411.

It should be noted that if the first modem equipped facsimile machine 102 does not require receiving a dial tone or generating DTMF digits, the telemetry device 104 bypasses generating a dial tone or receiving DTMF digits and dials the dial stored number to the cell tower 106. Whether or not the dial tone or DTMF digits are generated or received, respectively, the communication between the first modem equipped facsimile machine 102 and the telemetry device 104 further includes the modem 204 of the telemetry device 104 to handshake with the modem of the first modem equipped facsimile machine 102. Once the handshake between the first modem equipped facsimile machine 102 and the telemetry device 104 occurs, the manager 224 can establish a bi-directional communication pathway that relays data between the first modem equipped facsimile machine 102 and the second modem equipped facsimile machine 112, as shown in block 412.

When the communication between the first modem equipped facsimile machine 102 or the second modem equipped facsimile machine 112 is completed, the modem-equipped device manager 224 can detect whether the first modem equipped facsimile machine 102 or the second modem equipped facsimile machine 112 is terminating the communication pathway by hanging up, timing out, and/or dialing a DTMF digit (e.g., * or #), as shown in block 414. For example, when the first modem equipped facsimile machine 102 hangs up, the off-hook detector 208 detects an on-hook condition of the first modem equipped facsimile machine 102 and sends a signal to the processing device 200, which indicates a termination of the bi-directional communication pathway. When the second modem equipped facsimile machine 112 hangs up, the digital radio 222 sends a signal to the processing device 200, which indicates a termination of the bi-directional communication pathway.

FIG. 4B is a flow diagram that illustrates another embodiment of the operation of the modem equipped device data manager 224 of the telemetry device 104 shown in FIG. 2. It should be noted that some of the steps shown in FIG. 4B are similar to the steps in FIG. 4A, e.g., blocks 402, 406, 410, 412, and 414 of FIGS. 4A and 4B. The manager 224 is programmed to detect an off-hook condition of the first modem equipped facsimile machine 102, as shown in block 402. The manager 224 further may instruct the dial tone generator 210 to generate a dial tone to the first modem equipped facsimile machine 102, as shown in block 406.

When the first modem equipped facsimile machine 102 receives the dial tone from the telemetry device 104, the first modem equipped facsimile machine 102 may generate the DTMF digits to the telemetry device 104. In block 416, the manager 224 may detect the first occurrence of the DTMF digit from the first modem equipped facsimile machine 102. The manager 224 may also turn off the dial tone generator 210, as shown in block 410. The first modem equipped facsimile machine 102 may collect all DTMF digits coming from the first modem equipped facsimile machine 102 to determine the number to be dialed, as shown in flock 418.

Once all DTMF digits from the first modem equipped facsimile machine 102 are collected and stored in memory 202, the manager 224 may send a command signal to the digital cellular radio 222 to dial the stored number received via DTMF from the first modem equipped facsimile machine 102, as shown in block 420. Thus, the manager 224 instructs the cellular radio 222 to link to the cell tower 106 to establish communication with the second modem equipped facsimile machine 112.

The communication between the first modem equipped facsimile machine 102 and the telemetry device 104 further requires the modem 204 of the telemetry device 104 to handshake with the modem of the first modem equipped facsimile machine 102. Once the handshake between the first modem equipped facsimile machine 102 and the telemetry device 104 occurs, the manager 224 can establish a bi-directional communication pathway that relays data between the first modem equipped facsimile machine 102 and the second modem equipped facsimile machine 112, as shown in block 412.

When the communication between the first modem equipped facsimile machine 102 and the second modem equipped facsimile machine 112 is completed, the manager 224 can detect whether the first modem equipped facsimile machine 102 or the second modem equipped facsimile machine 112 is terminating the communication pathway by hanging up, timing out, and/or dialing a DTMF digit (e.g., * or #), as shown in block 414. For example, when the first modem equipped facsimile machine 102 and the second modem equipped facsimile machine 112 do not transmit data for a period of time and/or transmit a special DTMF digit (e.g., * or #) the manager 224 detects the idle time of no data transmission and/or the special DTMF digit, the manager 224 turns off the modem 204 and the digital cellular radio 222.

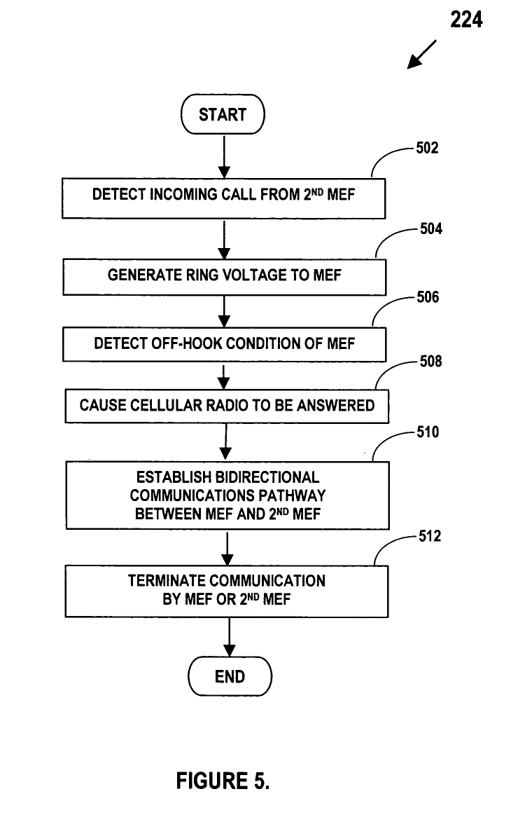

FIG. 5 is a flow diagram that illustrates an embodiment of operation of the modem-equipped device data manager 224 of the telemetry device 104 shown in FIG. 2 in which the telemetry device 104 receives instruction data from a second modem equipped facsimile machine 112. In FIG. 5, the modem-equipped device data manager 224 may detect an incoming call from the second modem equipped facsimile machine 112 via the digital cellular radio 222, as shown in block 502. The incoming call may comprise data as to documents or instruction data, which is relayed by the processing device 200 to the first modem equipped facsimile machine 102. The manager 224 may generate a ring voltage to the first modem equipped facsimile machine 102, as shown in block 504. When the first modem equipped facsimile machine 102 detects the ring voltage, the first modem equipped facsimile machine 102 goes off-hook.

In block 506, the manager 224 may detect an off-hook condition of the first modem equipped facsimile machine 102. In block 508, the manager 224 may cause the digital cellular radio 222 to answer the incoming call from the second modem equipped facsimile machine 112. The manager 224 may instruct the modem 204 of the telemetry device 104 to handshake with the modem of the first modem equipped facsimile machine 102. Once the handshake between the first modem equipped facsimile machine 102 and the telemetry device 104 occurs, the manager 224 can establish a bidirectional communication pathway that relays data between the first modem equipped facsimile machine 102 and the second modem equipped facsimile machine 112, as shown in block 510.

In block 512, the manager 224 can detect whether the first modem equipped facsimile machine 102 or the second modem equipped facsimile machine 112 is terminating the communication pathway by hanging up, timing out, and/or dialing a DTMF digit (e.g., * or #). For example, when the first modem equipped facsimile machine 102 and the second modem equipped facsimile machine 112 do not transmit data for a period of time and/or transmit a special DTMF digit (e.g., * or #), the manager 224 detects the idle time of no data transmission and/or the special DTMF digit, the manager 224 turns off the modem 204 and the digital cellular radio 222.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A telemetry digital data communication system comprising:
a second modem equipped facsimile machine;
at least one first modem equipped facsimile machine that utilizes a modem for data communication; and
a telemetry device for the first modem equipped facsimile machine comprising:
a processor for communicating with the first modem equipped facsimile machine; and
a modem for facilitating the processor to communicate the digital data from the first modem equipped facsimile machine to the digital cellular radio; and
a digital cellular radio for communicating with the processor and the second modem equipped facsimile machine.

2. The system as defined in claim 2, further comprising a two-wire communication line between the first modem equipped facsimile machine and the telemetry device.

3. The system as defined in claim 1, further comprising a cell tower for communication with the digital radio, and a first mobile switching center and PSTN for establishing bi-directional communication with the second modem equipped facsimile machine.

4. The system as defined in claim 3, wherein the telemetry device further comprises a UART coupled to the processor and modem and a second UART coupled to the processor and cellular radio.

5. The system as defined in claim 2, wherein the telemetry device further comprises:
a dial tone generator to generate a dial tone to the first modem equipped facsimile machine; and
a dual tone multi-frequency (DTMF) digit detector to determine whether a DTMF digit was transmitted by the first modem equipped facsimile machine.

6. The system as defined in claim 5, wherein the telemetry device further comprises:
a ring voltage generator for enabling communication with the first modem equipped facsimile machine;
a loop current generator to maintain current flow through the two-wire data transmission line when the telemetry device communicates with the first modem equipped facsimile machine; and
an off-hook detector to determine whether the first modem equipped facsimile machine is in an off-hook condition.

7. The system as defined in claim 3, wherein the first mobile switching center further comprises a modem bank as a part of the first mobile switching center for the transmission of data over the system.

8. The system as defined in claim 3, wherein the first mobile switching center is designed to handle the transmission of data in packets of data over the system.

9. The system as defined in claim 6, further comprising a modem-equipped device data manager connected to the processor, said modem-equipped device data manager having software to manage the data being transmitted so as to separate the pages in a document being transmitted.

10. The system as defined in claim 1, in which the digital cellular radio communicates with the second modem equipped facsimile machine via a cell tower connected to a first mobile switching center and PSTN, which is connected to a second mobile switching center which is connected to a cell tower for establishing the bi-directional transmission of data with a second telemetry device connected to the second modem equipped facsimile machine.

11. The system as defined in claim 1, in which the digital cellular radio communicates with the second modem equipped facsimile machine via a cell tower connected to a mobile switching center for establishing the bi-directional transmission of data with a second telemetry device connected to the second modem equipped facsimile machine.

12. The system as defined in claim 3, wherein the telemetry device further comprises:
a dial tone generator to generate a dial tone to the first modem equipped facsimile machine; and
a dual tone multi-frequency (DTMF) digit detector to determine whether a DTMF digit was transmitted by the first modem equipped facsimile machine.

13. The system as defined in claim 12, wherein the telemetry device further comprises:
a ring voltage generator for enabling communication with the first modem equipped facsimile machine;
a loop current generator to maintain current flow through the two-wire data transmission line when the telemetry device communicates with the first modem equipped facsimile machine; and
an off-hook detector to determine whether the first modem equipped facsimile machine is in an off-hook condition.

14. The system as defined in claim 13, further comprising a modem-equipped device data manager connected to the processor, said modem-equipped device data manager having software to manage the data being transmitted so as to separate the pages in a document being transmitted.

15. The system as defined in claim 10, wherein the telemetry device further comprises a UART coupled to the processor and modem and a second UART coupled to the processor and cellular radio.

16. The system as defined in claim 15, wherein the telemetry device further comprises:
a dial tone generator to generate a dial tone to the first modem equipped facsimile machine; and
a dual tone multi-frequency (DTMF) digit detector to determine whether a DTMF digit was transmitted by the first modem equipped facsimile machine.

17. The system as defined in claim 16, wherein the telemetry device further comprises:
a ring voltage generator for enabling communication with the first modem equipped facsimile machine;
a loop current generator to maintain current flow through the two-wire data transmission line when the telemetry device communicates with the first modem equipped facsimile machine; and
an off-hook detector to determine whether the first modem equipped facsimile machine is in an off-hook condition.

18. The system as defined in claim 17, further comprising a modem-equipped device data manager connected to the processor, said modem-equipped device data manager having software to manage the data being transmitted so as to separate the pages in a document being transmitted.

19. The system as defined in claim 11, wherein the telemetry device further comprises a UART coupled to the processor and modem and a second UART coupled to the processor and cellular radio.

20. The system as defined in claim 19, wherein the telemetry device further comprises:
a dial tone generator to generate a dial tone to the first modem equipped facsimile machine; and a dual tone multi-frequency (DTMF) digit detector to determine whether a DTMF digit was transmitted by the first modem equipped facsimile machine.

21. The system as defined in claim 20, wherein the telemetry device further comprises:
a ring voltage generator for enabling communication with the first modem equipped facsimile machine;
a loop current generator to maintain current flow through the two-wire data transmission line when the telemetry device communicates with the first modem equipped facsimile machine; and
an off-hook detector to determine whether the first modem equipped facsimile machine is in an off-hook condition.

22. The system as defined in claim 21, further comprising a modem-equipped device data manager connected to the processor, said modem-equipped device data manager having software to manage the data being transmitted so as to separate the pages in a document being transmitted.

23. A telemetry digital data communication system comprising:
a second modem equipped facsimile machine;
at least one first modem equipped facsimile machine that utilizes a modem for data communication;
a telemetry device for at least one first modem equipped facsimile machine comprising:
a processor for communicating with the first modem equipped facsimile machine;
a digital cellular radio for communicating with the processor and the second modem equipped facsimile machine;
a ring voltage generator for enabling communication with the first modem equipped facsimile machine;
a loop current generator to maintain current flow through the two-wire data transmission line when the telemetry device communicates with the first modem equipped facsimile machine; and
an off-hook detector to determine whether the first modem equipped facsimile machine is in an off-hook condition;
a two-wire communication line between the first modem equipped facsimile machine and processor,
wherein the processor relays digital data from the first modem equipped facsimile machine to the digital cellular radio in which the digital cellular radio facilitates transmitting the digital data to the second modem equipped facsimile machine.

24. The system as defined in claim 23, further comprising a modem-equipped device data manager connected to the processor, said modem-equipped device data manager having software to manage the data being transmitted so as to separate the pages in a document being transmitted.

25. A telemetry device for facilitating digital communication between a first modem equipped facsimile machine and a second modem equipped facsimile machine, the telemetry device comprising:
a processor for communicating with the first modem equipped facsimile machine; and
a digital cellular radio for communication with the processor and the second modem equipped facsimile machine;
a ring voltage generator for enabling communication with the first modem equipped facsimile machine;
a two-wire data transmission line between the first modem equipped facsimile machine and processor;
a loop current generator to maintain current flow through the two-wire data transmission line when the telemetry device communicates with the first modem equipped facsimile machine; and
an off-hook detector to determine whether the first modem equipped facsimile machine is in an off-hook condition;
wherein the processor is for relaying the digital data from the first modem equipped facsimile machine to the digital cellular radio in which the digital cellular radio facilitates transmitting the digital data to the second modem equipped facsimile machine.

26. The device as defined in claim 25, wherein the telemetry device further comprises a UART coupled to the processor and modem and a second UART coupled to the processor and cellular radio.

27. The device as defined in claim 25, further comprising a modem-equipped device data manager connected to the processor, said modem-equipped device data manager having software to manage the data being transmitted so as to separate the pages in a document being transmitted.

28. A telemetry device for facilitating digital communication between a first modem equipped facsimile machine and a second modem equipped facsimile machine, the telemetry device comprising:
a processor for communicating with the modem of the first modem equipped facsimile machine; and
a digital cellular radio for communicating with the processor and the second modem equipped facsimile machine;
wherein the processor is for relaying the digital data from the modem of the first modem equipped facsimile machine to the cellular radio in which the digital cellular radio facilitates transmitting the digital data to the second modem equipped facsimile machine.

29. A method for facilitating digital data communication between a first modem equipped facsimile machine and a second modem equipped facsimile machine system via a digital cellular radio, the method comprising the steps of:
detecting whether the first modem equipped facsimile machine is off hook;
establishing a bidirectional communication pathway that relays data between the first modem equipped facsimile machine and the second modem equipped facsimile machine which is facilitated by a processor; and
terminating the pathway.

30. The method as defined in claim 29 further comprising dialing the digital cellular radio for communication between the first modem equipped facsimile machine and the second modem equipped facsimile machine.

31. The method as defined in claim 30, further comprising:
generating a dial tone to the modem equipped device; and
detecting a dual tone multi frequency (DTMF) from the first modem equipped facsimile machine.

32. The method of claim 31, further comprising the relaying of a plurality of pages of a document from the first modem equipped facsimile machine to the second modem equipped facsimile machine and managing the data being sent so that that pages are correctly separated when received by the second modem equipped facsimile machine.
